(19) United States
(12) Patent Application Publication
(10) Pub. No.: US 2004/0180126 A1
(43) Pub. Date: Sep. 16, 2004

(54) Animal feed with low pufa concentration

(76) Inventor: Arie Karst Kies, Pijnacker (NL)

Correspondence Address: MORRISON & FOERSTER LLP, 755 PAGE MILL RD, PALO ALTO, CA, 94304-1018, US

(21) Appl. No.: 10/484,324

(22) PCT Filed: Jul. 22, 2002
(86) PCT No.: PCT/EP02/08159

(30) Foreign Application Priority Data
Jul. 20, 2001 (EP) 013062484

(51) Int. Cl. A23D 7/00

(52) U.S. Cl. 426/601

(57) ABSTRACT

The use of low concentrations of (a) PUFA (s) in an animal feed for monogastric and/or non-ruminant animals is disclosed to improve growth and feed conversion ratio. The concentration can be much lower than expected from the art, namely from 0.1 to 0.0001 g/kg feed, and yet still be effective. This may enable farmers to use lower concentrations of PUFA (s) in feed and hence reduce the cost of the feed. The feed may also have one or more antimicrobial enzymes present.

### FIELD OF THE INVENTION

This invention relates to the use of low concentrations of one or more polyunsaturated fatty acids (PUFA(s)), such as arachidonic acid, in (mono-gastric and/or non-ruminant) animal feed (such as below 0.1 g of PUFA per kg of animal feed). Even at these small amounts it has been found that the PUFA(s) may improve growth and feed conversion ratio of pigs, poultry, fish and veal calves. Additionally, one or more (e.g. anti-microbial) enzymes can be present in the feed as well.

### BACKGROUND OF THE INVENTION

Animals such as pigs, poultry, veal calves and fish are grown intensively for the production of meat, fish and eggs. These animals are fed diets containing a variety of raw materials of animal and/or vegetable origin to supply energy and protein. Most of the feed that is consumed is produced commercially by the compound feed industry but a significant part is produced on the farm and fed directly. The feed is supplemented with vitamins and minerals to meet the animals' requirements for these essential nutrients. The use of industrially produced enzymes as feed additives has become almost common practice. Examples of such enzymes comprise phytases, α-amylases, proteases and various plant cell wall degrading enzymes such as β-glucanases, endoxylanases and mannanases. These enzymes are used to improve growth and feed conversion ratio and to reduce the environmental pollution caused by manure from pigs, poultry and fish. However, feed costs are the most important cost factor in animal production.

During the 1950's it was realized that the addition of a small amount of antibiotics to animal feed resulted in improved zootechnical results (such as growth, feed utilization) in monogastric animals. Nowadays, antibiotics are used routinely as feed additives. The mode of action of these antibiotics on the improvement of growth and feed conversion ratio is still not fully understood. The generic term for this class of feed additives is growth promoters and examples include a vilamycin, virginiamycin, tylosin, flavomycin and avoparcin.

The resistance of human pathogenic bacteria to antibiotics has been increasing rapidly. This has made it more difficult to cure people from bacterial infections. The widespread use of antibiotics in animal feed has been blamed by various experts for accelerating the build-up of resistance to various antibiotics. This has led to a ban on the use of most antibiotics as growth promoters in animal feed in the European Union. Nowadays, within the EU only a few growth promoters are still allowed to be used. It is likely that countries outside the EU will follow this ban due to pressure from consumer and health care organisations and trade interests. The feed industry therefore is very much interested in natural additives with growth promoting effects without any therapeutical use in humans.

As an alternative to the use of antibiotics in animal feeds, the use of two antimicrobial enzymes in combination with a PUFA has been explored as described in WO-A-00/21381. WO-A-00/21381 suggests using two different antimicrobial enzymes, and a PUFA at from 0.1 g to 1000 g per kg of animal feed. It has now been found, unexpectedly, that even lower PUFA concentrations (in animal feed), below that disclosed in WO-A-00/21381, are still effective and are beneficial to the animals.

It is desirable for farmers and the compound feed industry to obtain an optimum growth and feed conversion ratio, at minimum cost, in a sustainable way, respecting demands from both consumer and health care organisations alike. However, it is by no means immediately evident that by decreasing the concentration of an additive (e.g. a PUFA) in an animal feed this would not materially decrease efficiency.

### DESCRIPTION OF THE INVENTION

The present invention is based on the finding that lower concentrations of PUFA than those previously described can be used to achieve the same or similar improvements in growth and feed conversion ratio (as the previously disclosed higher concentrations). This means that less PUFA can be used to achieve a similar effect, resulting in a reduction in the cost of the animal feed composition and a decrease in any possible side effects.

The effect of the PUFA can be increased by the addition of one or more antimicrobial enzymes to the composition of the invention. The PUPA and the enzyme(s) may act synergistically and hence result in a higher improvement in growth and feed conversion than either component individually.

A first aspect of the present invention relates to an animal feed composition, suitable for a monogastric or non-ruminant animal, the composition comprising from below (i.e. no more than) 0.1 down to 0.0001 g of PUFA per kg of feed. Typically, the composition will comprise from 0.08, 0.07 or 0.05 to 0.001 or 0.0001 g of PUFA per kg of feed. Preferably it is from 0.02, 0.01 or 0.005 to 0.002 g of PUFA per kg of feed, more preferably from 0.01 to 0.004 or 0.001 g of PUFA per kg of feed.

These amounts refer to the weight of the PUFA present. Hence if the PUFA is added in the form of an oil (e.g. having for example from 30 to 40% of the PUFA), then the amount of oil present (or added) can be calculated accordingly, for example by multiplying the amount of the PUFA by 100/X where X is the (weight) percentage of the PUFA in the oil. Hence, for example with a 30 or 35 to 40, 45 or 50% PUFA content, the amount of oil that can be added may vary proportionally. Thus the oil maybe from 0.33 or 0.25 down to 0.00033 or 0.00025 g per kg of feed. Other amounts and intermediate ranges can be calculated on the same basis, using the figures for the PUFA amounts in the previous paragraph.

The amount of the PUFA is preferably such that it improves the growth (e.g. growth in body weight) and/or feed conversion ratio of the animal.

Polyunsaturated Fatty Acids (PUFAs)

The PUFA can either be a single PUFA or two or more different PUFAs. If there are 2 or more PUFAs then either each PUFA or the total amount of all the PUFAs is within the amounts specified (e.g. a total PUFA content of no more than 0.1 g/kg feed). The or each PUFA can be of the n-3 or n-6 family. Preferably it is a C18, C20 or C22 PUFA or a PUFA with at least 18 carbon atoms and 3 double bonds. The PUFA(s) can be provided in the form of a free fatty acid, a salt, as a fatty acid ester (e.g. methyl or ethyl ester), as a phospholipid and/or in the form of a mono-, di- or triglyceride.

Suitable (n-3 and n-6) PUFAs include:

docosahexaenoic acid (DHA, 22:6 Ω3), suitably from algae or fungi, such as the (dinoflagellate) Crypthecodinium or the (fungus) Thraustochytrium;

γ-linolenic acid (GLA, 18:3 Ω6);

α-linolenic acid (ALA, 18:3 Ω3);

conjugated linoleic acid (octadecadienoic acid ,CLA);

dihomo-γ-linolenic acid (DOGLA, 20:3 Ω6);

arachidonic acid (ARA, 20:4 Ω6); and

eicosapentaenoic acid (EPA, 20:5 Ω3).

Preferred PUFAs include arachidonic acid (ARA), docosohexaenoic acid (DHA), eicosapentaenoic acid (EPA) and/or γ-linoleic acid (GLA). In particular, ARA is preferred.

The PUFAs may be from a natural (e.g. vegetable or marine) source or may be derived from or produced by a single cell or microbial source. Thus the PUFA may be of (or from) microbial, algal or plant origin (or source). In particular, the PUFA may be produced by a bacteria, fungus or yeast. Fungi are preferred, preferably of the order Mucorales, for example Mortierella, Phycomyces, Blakeslea, Aspergillus, Thraustochytrium, Pythium or Entomophthora. The preferred source of ARA is from Mortierella alpina, Blakeslea trispora, Aspergillus terreus or Pythium insidiosum. Algae can be dinoflagellate and/or include Porphyridium, Nitszchia, or Crypthecodinium (e.g. Crypthecodinium cohnii). Yeasts include those of the genus Pichia or Saccharomyces, such as Pichia ciferii. Bacteria can be of the genus Propionibacterium.

The PUFA(s) may be present in or be added to the composition as an (e.g. edible) oil. The oil may be a liquid (at room temperature). The oil may be a microbial (e.g. single cell), oil. A suitable oil that includes ARA is available from DSM N.V., Wateringseweg 1, P.O. Box 1, 2600 MA Delft, The Netherlands, under the trade mark VEVODAR™. Another commercially available (ARA) oil is ARASCO™ from Martek Corporation, 6480 Dobbin Road, Columbia, Md. 21045, United States of America. Other PUFAs are available, for example DHA as a DHA oil (DHASCO™ from Martek Corporation or DHA from Pronova, Norway, under the trade mark EPAX™).

Vegetable oils include blackcurrant, borage and primrose oils, and often contain an Ω6 PUFA, e.g. GLA. They also include olive, sunflower and soy bean, soy flower oils, for example cooking and/or salad oils.

A number of documents describe the production of crude PUFA oils. Microbial oils containing ARA are disclosed in WO-A-92/13086 (Martek), EPA in WO-A-91/14427 (Martek) and DHA in WO-A-91/11918 (Martek). Various methods for extracting PUFA oils from microbial sources can be found in WO-A-97/36996 and WO-A-97/37032 (both Gist-Brocades). Preparation of ARA, DHA and EPA-containing oils is also described in WO-A-92/12711 (Martek).

In the oil, it is preferred that most of the PUFA(s) is/are in the form of triglycerides. Thus, preferably at least 50%, such as at least 60%, or more preferably at least 70%, of the PUFA(s) is in triglyceride form. However, the amount of triglycerides may be higher, such as at least 85%, preferably at least 90%, more preferably at least 95% or 98% of the oil. Of these triglycerides, preferably at least 40%, such as at least 50%, and more preferably at least 60% of the PUFA is present at the α-position of the glycerol (present in the triglyceride backbone), also known at the 1 or 3 position. It is preferred that at least 20%, such as at least 30%, more preferably at least 40% of the PUFA(s) is at the β(2) position.

The microbial oil may be a crude oil. It may have been extracted from microbes or single cells, algae, for example by using a solvent, such as supercritical carbon dioxide, hexane or isopropanol.

Enzymes

The feed composition may also comprise one or more antimicrobial enzyme(s). In a preferred embodiment of the invention the composition comprises two or more antimicrobial enzynmes.

Preferably one or more of the antimicrobial enzymes are antibacterial enzymes. These enzymes may be of different types and/or may have different activity. They may reduce the amount of essential nutrients available to micro-organisms.

One, e.g. a first, enzyme may be able to disrupt the cell wall of bacteria. The enzyme may be one that can attack or degrade peptidoglycans. For example, the enzyme may be able to cleave off peptidoglycans. A preferred enzyme for this task is lysozyme. This (first) enzyme may be present at a concentration of from 1,000 to 1,000,000 or 1000,000, such as from 5,000 or 10,000 to 150,000 or 1,000,000 more preferably from 15,000 or 25,000 to 100,000 or 500,000 Shugar units per kg of animal feed. Preferably this first enzyme may be present at an amount, by weight, to give a final concentration in the animal feed of from 0.04 to 44 milligrams per kg of feed, preferably from 0.2 or 0.4 to 6.7 or 20 milligrams per kg of feed, and more preferably from 0.8 or 1.1 to 4.4 or 10 (e.g. 1 to 5) milligrams per kg of feed, if for example if using hen egg white lysozyme.

The second enzyme may be able to generate a compound that is toxic to the bacteria. This may be the same bacteria, or different, from the bacteria whose cell walls can be disrupted or degraded by the first enzyme. The compound is preferably a peroxide, e.g. hydrogen peroxide. Thus preferred enzyme are oxidases. Particularly preferred is glucose oxidase. This second enzyme may be present at a concentration to give from 10 to 10,000, preferably from 25 or 100 to 1,500 or 5,000, and more preferably from 50 or 200 to 1,000 or 2,500 Sarrett U per kilogram of animal feed. Preferably this second enzyme may be present at an amount, by weight, to give a final concentration in the animal feed of from 0.05 to 50 milligrams per kg of feed, preferably from 0.08 or 0.13 to 7.5 or 25 milligrams per kg of feed, and more preferably from or 0.25 or 0.5 to 5.0 or 10 milligrams per kg of feed, if for example using an (e.g. A. niger-derived) glucose oxidase.

A third or other enzyme may be a lipase, e.g. a phospholipase that is toxic to bacteria. This third enzyme may be present at a concentration to give from 5 to 5,000, preferably from 10 or 25 to 2,500 or 4,000, and more preferably from 50 or 100 to 1,000 or 700 (Egg Yolk) units per kilogram of animal feed. Preferably this third enzyme may be present at an amount, by weight, to give a final concentration in the animal feed of from 0.005 to 5 milligrams per kg of feed, preferably from 0.01 to 0.025, to 2.5 or 4 milligrams per kg of feed, and more preferably from 0.05 or 0.1 to 1.0 or 0.7 milligrams per kg of feed, if for example using pig pancreas PLA2 (e.g. produced in A. niger).

Enzymes can function as antimicrobial agents in the following ways:

a) disruption of the cell wall;

b) generation of a toxic compound;

c) removal of an essential nutrient; or

d) inactivation of enzymes essential for growth.

Each of these will be discussed in turn.

a) Microbial cell walls vary in structure for fungi, yeasts, gram negative and gram positive bacteria. One can need different enzymes to disrupt the cell wall of these different types of microorganisms. The fungal and yeast cell wall, for example, may be disrupted by a mannanase, chitinase and/or beta-glucanase. The bacterial cell wall, however, is not sensitive to these enzymes due to a different type of structure. Gram positive organisms have a peptidoglycan layer covered by some protein but essentially consists of peptidoglycan only. This substrate may be degraded by lysozyme (1,4-b-acetylmuramidase). This can cleave peptidoglycans between the C1 of N-acetyl-muramic acid and the C-4 of N-acetylglucosamine.

The peptidoglycan layer is covered by a tight lipopolysaccharide-protein-divalent cation-phospholipid layer in gram negative bacteria This layer can hinder the efficacy of lysozyme in gram negative bacteria Agents capable of disrupting this tight lipopolysaccharide layer stimulate the action of lysozyme by giving the enzyme access to the peptidoglycan layer.

b) Oxidases can produce hydrogen peroxide which is lethal to most microorganisms. Glucose oxidase , for example, catalyses the conversion of glucose into gluconic acid and hydrogen peroxide. Xanthine oxidase, present in milk, is also capable of generating hydrogen peroxide.

Other antimicrobial compounds which may be enzymatically generated comprise hypothiocyanate (produced by lactoperoxidase), chloramines (produced by myeloperoxidase), free fatty acids (produced by lipase), poly-unsaturated fatty acids, lysophosphatidylcholine (produced by phospholipase A2) and xylitol-5-phosphate (produced by xylitol phosphorylase). This list is by no means exhaustive, however.

c) Oxygen may be removed from the media by an oxidase such as glucose oxidase. Complete removal of oxygen prevents the growth of aerobic microorganisms.

d) Enzymes essential for growth of microorganisms may be inactivated by means of other enzymes. A sulffiydryl oxidase, for example, may be capable of inactivating enzymes which depend on active sulfhiydryl groups for their activity.

All the antimicrobial enzymes can be produced on industrial scale and/or may be recombinant. Lysozyme is commercially available, isolated from egg white, or may be recombinant. The enzyme may be naturally occurring or may be a (e.g. recombinant) variant or mutant thereof.

The antibacterial enzyme is preferably recombinantly produced such as by expression of a heterologous gene or cDNA in a suitable organism, or alternatively by homologous (over)expression of a suitable endogenous gene. The glucose oxidase gene, for example, has been overexpressed in recombinant systems (WO-A-89/12675, Chiron). Lysozyme (from egg white) can be recombinantly expressed by expression of the gene in Aspergillus niger (Archer, D. B. et al, Bio/Technology 8: 741-745 (1990)). A lysozyme mutant (produced by protein engineering) can also be used which may have better heat stability and/or stronger antimicrobial action.

A second aspect of the invention relates to a premix or additive composition to be added to one or more edible feed substance(s) or ingredient(s), for example to prepare or for supplementation to an existing feed to form a feed composition (of the first aspect). This may comprise from 1.0 (or 100) to 0.001 ( or 0.1) g/kg of PUFA(s) in the composition. Preferably the additive or premix comprises from 10 to 1000, such as from 25 or 50 to 750, preferably from 75 or 100 to 250 or 500, times as much of the PUFA (or other components, such as enzymes) as the feed. This is because the premix can be “diluted” by a factor of 10 to 1,000 (so that the premix constitutes 10% to 0.1% of the final feed) when making the animal feed. This premix may be in the form of granules or pellets.

A third aspect of the invention relates to a process for the preparation of an animal feed composition, the process comprising adding to (or supplementing) an animal feed, or to one or more edible feed substance(s) or ingredient(s), one or more PUPA(s) to give a (final) concentration of from (below) 0.1 to 0.0001 g per kg of feed. Typically the PUFA(s) will be present at a concentration as described for the first aspect.

The PUFA added may be any of those described in the first aspect of the invention, but will typically be ARA. Preferably an antimicrobial enzyme and more preferably two or more antimicrobial enzymes will also be added or present. These antimicrobial enzymes may be any of those described in the first aspect of the invention, but will preferably be one or more of glucose oxidase, lysozyme and phospholipase. Typically the enzymes will be two of glucose oxidase, lysozyme and phospholipase (such as the first two) or preferably all three.

Supplementation of Animal Feed

The PUFA(s) and/or antimicrobial enzyme(s) can be added to the animal feed composition separately from the feed substance(s) or ingredient(s), individually or in combination with other feed additives. Alternatively, or in addition, the PUFA(s) and/or antimicrobial enzyme(s) can be an integral part of one of the feed substances. The invention includes both preparing a feed composition with the PUFA(s) (and antimicrobial enzyme(s) if necessary) or supplementing an existing feed composition with the PUFA(s) (and antimicrobial enzymes if present), in which case the PUFA(s) may be present in the premix or additive composition of the second aspect.

A particularly preferred method for the (exogenous) addition of the PUFA(s) and/or the (antimicrobial) enzyme(s) to animal feed is to add one or more of the PUFA(s) and/or antimicrobial enzyme(s) as transgenic plant material and/or (e.g. transgenic) seed. The PUFA(s) and/or enzyme(s) may thus have been synthesized through heterologous gene expression, for example the gene encoding the desired (antimicrobial) enzyme(s) may be cloned into a plant expression vector, under control of the appropriate plant expression signals, e.g. a tissue specific promoter, such as a seed specific promoter. The same technique can be used for PUFA(s) where the gene(s) encode(s) (an) enzyme(s) participating in PUFA biosynthetic pathway(s). The expression vector(s) containing the gene(s) can be subsequently transformed into plant cells, and transformed cells can be selected for regeneration into whole plants. The thus obtained transgenic plants can be grown and harvested, and those parts of the plants containing the heterologous (to the plant) PUFA(s) and/or antimicrobial enzyme(s) can be included in one of the compositions, either as such or after further processing.

Reference here is made to WO-A-91/14772 which discloses general methods for the (heterologous) expression of enzymes in (transgenic) plants, including methods for seed-specific expression of enzymes. The heterologous PUFA(s) and/or antimicrobial enzyme(s) may be contained in the seed of the transgenic plants or it may be contained in other plant parts such as roots, stems, leaves, wood, flowers, bark and/or fruit.

The addition of the PUFA(s) and/or antimicrobial enzyme(s) in the form of transgenic plant material, e.g. transgenic seed containing the PUFA(s) and/or antimicrobial enzyme(s), may require the processing of the plant material so as to make the PUFA(s) antimicrobial enzyme(s) available, or at least improve its availability. Such processing techniques may include various mechanical (e.g. milling and/or grinding) techniques or thermomechanical treatments such as extrusion or expansion.

The PUFA(s) and/or antimicrobial enzyme(s) may be added to the feed composition at a concentration that varies as a function of diet composition, type of PUFA and/or antimicrobial enzyme and target animal species.

Preferably the compositions of the invention do not contain any antibiotics and/or coccidiostats. The composition(s) of the invention may also be free of (an added or supplemented) mineral component (such as zinc and/or iodine) and/or ascorbic acid.

Although the anti-nicrobial enzyme(s) and the PUFA(s) can all be produced by a micro-ogranism added to a feed composition, for many situations (the producing) micro-organisms will not be added to or present in the feed, or at least live (or viable) organisms, such as bacteria, are not present in the feed. Hence in this case the composition is free from any microorganisms that produced one or more of these compounds (or micro-organisms from Streptomyces). Furthermore, the composition may be devoid of micro-organisms that produce lactic acid inside the animal (e.g. those of the genus Lactobacillus or Enterococcus). Typically, before addition of the PUFA(s) and, if necessary, antimicrobial enzyme(s), the feed composition will be heated to kill, or reduce the number of, any bacteria present in the feed.

In some embodiments it is preferred that the or each PUFA (and any enzyme) is still present inside the microorganism (that produced it). Hence the PUFA may be added as microorganism cells, such as biomass. The cells may be mixed with the animal feed (or with one or more feed substance(s) or ingredients). The microorganism may produce not only the PUFA but also one or more of the enzymes.

In a typical PUFA production (by fermentation) process the amount of PUFA produced may be from 7 to 10 g/kg broth (i.e. wet biomass). Hence the amount of broth (wet cells) to be added, or present in, the feed composition can be calculated by multiplying the amount of PUFA desired by a factor of 70 or 100 (e.g. 10 g broth/kg feed gives a PUFA concentration of 0.1 g/kg feed). If a dried biomass is added or used instead, then the dried cells can have a PUFA content of 100 to 200, such as 140 to 180 g/kg cells, and so to obtain the amount of PUFA one multiplies the amount of PUFA by 10 or 20 to give the amount of dried cells per kg feed.

Uses of Animal Feed

A fourth aspect of the present invention relates to a process for promoting growth and/or feed conversion in a monogastric or non-ruminant animal. This process comprises feeding the animal one or more PUFAs at a concentration of from (less than) 0.1 g to 0.0001 g per kg of feed (or a feed composition of the first aspect or a composition prepared by the third aspect).

Suitable animals include farm, monogastric and/or non-ruminant animals such as pigs (or piglets), poultry (such as chickens, turkeys, laying hens), veal calves or aquatic (e.g. marine) animals (for example fish).

The compositions of the invention may be active in vivo (e.g. not in vitro), or only once ingested or inside the animal. The PUPA may thus not be effective (for example as an antimicrobial agent) since the composition may be too dry, for example it has a water content of no more than 10, 20, 30, 40 or 50%. Once ingested and inside the animal (e.g. in the stomach or rumen) there may be sufficient liquid (or water) for the PUFA to become active or effective, such as an antimicrobial agent.

Animal Feed Components

The compositions of the invention, in particular additive or premix compositions, can be either in liquid or solid form. If a solid, then this may be a powder, a granulate, extrudate or it may be pellets. For a solid form, the amount of water present may be below 20, 15 or even 10%, such as from 2 to 10%, 3 to 8% or 4 to 7%. The PUFA may be present at from 1 to 30%, such as 2 to 20%, for example 3 to 15%, and optimally at from 4 to 14% (on a dry matter basis). The remainder may comprise carbohydrates and/or carbohydrate polymers (such as starch and/or modified starch), for example at least 70, 80, 90 or 95%, such as from 75 to 90%. The composition may have a coating, for example if it is in a pellet, granulate, or extrudate form. There may thus be one or more coats on the outside of the composition, comprising one or more coating materials. If present, the coating (or coating materials) may be present at from 1 to 10%, such as from 2 to 6%, optimally at from 3 to 5%. The composition may have one or more stabilisers (such as glycerol and/or sorbitol) and/or one or more preservatives (such as sorbate and/or benzoate).

If the composition is a liquid, then the water (or moisture) content will be higher. The water content may be up to 40, 50 or 60%, for example from 25 to 65%, optimally from 35 to 55%. If a stabiliser is present, this may be at an amount of from 45 to 65%, such as from 50 to 60%, optimally from 52 to 58%. The stabiliser is preferably sorbitol and/or glycerol.

A description of the preparation of pellets and granules, in particular carbohydrate based enzyme granulates, is described in WO-A-98/54980 (International Application No. PCT/EP98/03327), the contents of which is incorporated by reference.

The composition may comprise a carrier which may comprise at least 15% of an edible carbohydrate polymer. The carrier may be in particulate or powder form. However, if the composition is a liquid, it may be in the form of a solution or a slurry. The polymer preferably comprises glucose, or glucose-containing units, although it can contain glucopyranose units, amylose and/or amylopeptin. In addition, or instead of starch, a glucan, peptin or glycogen can be used. Preferably at least 15%, such as at least 30%, at least 40%, for example at least 60%, optimally at least 80% of the composition (or the solid carrier) comprises the carbohydrate polymer.

Additional details of enzyme-containing compositions for animal feed can be found in WO-A-98/55599 (international Application No. PCT/EP98/03328, the contents of this and all other documents referred to herein are hereby incorporated by reference). Although this document primarily deals with phytases, its teachings are equally applicable to other compounds, in particular enzymes.

Animal feed compositions of the first aspect will usually contain one or more feed ingredients or substances. These are ingredients and substances intended for consumption by an animal, and is therefore in a form suitable for ingestion and nutrition for an animal. This will therefore usually exclude human foodstuffs, or food substances or ingredients intended or destined for consumption by humans. Preferably the feed composition is both edible and digestible by the animal.

Suitably the substances and/or ingredients have a dry matter content of at least 80, 85, 90 or 95%. The protein content of the composition (or the substances and/or ingredients) may vary considerably, but may be from 5 to 20%, such as 10 to 15%, for example vegetable and/or plant products or parts thereof, such as buckwheat, rice, wheat, barley or corn. Substances or ingredients with higher protein contents, such as from 45 to 95%, e.g. 50 to 80%, may be provided, for example peanuts, poultry feathers, soy bean (or products thereof), sunflower (e.g. seeds) or casein. Preferred animal feed compositions may therefore comprise one or more of oats, pea (seeds), peanuts, soy beans, sunflower, canola, casein, coconut, corn, meat, millet, potato, rice, safflower and/or wheat. Preferably the composition (and substances or ingredients) have a crude fibre content below 30%, 25%, 20%, 15% or even below 10%. Similarly, the calcium content may be below 2%, such as 1%, below 0.5% and preferably less than 0.2%. The total phosphorous content of the (animal feed composition) is preferably from 2 to 0.01%, such as from 1 to 0.1%, optimally less than 0.5%.

The precise substances and ingredients can vary depending on the animal to be fed. An alternative composition may comprise one or more of bakery waste, sugar beet, brewers grain, canola, cassava, corn, fababean, fish (such as anchovy or herring meal), lentils, meat and/or millet.

Preferred features and characteristics of one aspect of the present invention are applicable to another aspect mutatis mutandis.

The present invention will now be described by way of example with reference to the following Examples which are provided by way of illustration and are not intended to limit its scope.

### EXAMPLES

### Characterization of Arachidonic Acid

Arachidonic acid (ARA) was obtained from DSM Food Specialties, Agri Ingredients, PO Box 1, 2600 MA DELFT, The Netherlands under the trade mark VEVODAR™. This is a microbial oil (ARA content at least 35%) obtained by culturing the fungus Mortierella alpina.

### Characterization of antimicrobial enzyme products

Glucose oxidase (EC 1.1.3.4), an oxidase capable of generating hydrogen peroxide, was obtained as a commercial product under the trade mark FERMIZYME GO™ 1500 from DSM Food Specialties, PO Box 1, 2600 MA DELFT, The Netherlands. This enzyme preparation exhibits an activity of 1500 Sarrett Units per gram. One Sarrett unit is the amount of enzyme that will cause an uptake of 10 mm³ of oxygen per minute in a Warburg manometer at 30□C in the presence of excess oxygen and 3.3% glucose monohydrate in a phosphate buffer with a pH of 5.9. The enzyme was produced by the fungus Aspergillus.

Lysozyme obtained from chicken egg-white was obtained as a commercial product under the trade mark DELVOZYME™ from DSM Food Specialties, PO Box 1, 2600 MA DELFT, The Netherlands. The product contains 20×10⁶ Shugar units/g product. One Shugar unit is defined as the amount of enzyme which causes a decrease of absorbance of 0.001 per minute at 450 mm and pH 6.2 at 25□C in a suspension of Micrococcus lysodeikticus (0.25 mg/ml) obtainable from Sigma Chemicals.

BMD® (Bacitracine Methylene Disalicylate) was obtained commercially from Alpharma Inc. (Animal Health Division, One Executive Drive, Fort Lee, N.J. 07024, USA) as BMD 50, a product containing 50 g active substance/lb.

Phospholipase was obtained through production of pig pancreas PLA2 in Aspergillus niger, as described in WO96/36244. Phospholipase concentrations are defined by Egg Yolk Units (EYU). One EYU is defined as the amount of phospholipase enzyme that releases 1 μmol of acid per minute from egg lecithin at pH 8 and 40° C.

Avilamycine was obtained commercially from Elanco Animal Health (500 East 96^{th} Street, Suite 125, Indianapolis, Ind. 46240, USA) under the trade mark Maxus™ G 200. This product contains 20% active substance (avilamycine).

### Comparative Examples 1 & 2 and Examples 3 to 5

Trials were carried out to determine the optimum concentration of arachidonic acid for broilers. The trial was performed using female and male broilers. Directly after arrival from the hatchery, the animals were randomly distributed over 40 floor pens with each pen housing 15 broilers. Eight pens were allocated to each treatment; therefore each treatment was replicated eight times (120 birds per treatment in total). The pens were set up in an artificially heated, illuminated and ventilated broiler house. The climatic conditions were as commonly applied. Animals were vaccinated according to the normal vaccination program. The experiment lasted until day 28 of age.

The experiment comprised the following treatments (Examples 1 to 5):

(1) basal diet (negative control);

(2) basal diet+10 mg/kg feed of the antimicrobial growth promoter avilamycine positive control);

(3) basal diet+arachidonic acid to a final concentration of 4 mg/kg feed;

(4) basal diet+arachidonic acid to a final concentration of 2 mg/kg feed; and

(5) basal diet+arachidonic acid to a final concentration of 1 mg/kg feed.

The antibiotic or arachidonic acid were mixed into the basal diet as appropriate. The feed was pelleted at 2.5 mm diameter (the temperature of the pellets did not exceed approximately 70° C. during this process). The feed was offered ad lib. to the animals, as was water.

The composition of the feed (basal diets) used was:

| Ingredients | Contents (%) |
|---|---|
| Wheat | 42 |
| Rye | 10 |
| Soybean meal | 19 |
| Full fat toasted soybeans | 5 |
| Rapeseed meal | 7.5 |
| Soy isolate | 2.5 |
| Maize gluten meal | 2.5 |
| Soy oil | 2 |
| Blended animal fat | 6 |
| Minerals, vitamins and amino acids* | 35 |
| Calculated contents: | |
| ME_{broilers} (MJ/kg) | 12.0 |
| Crude protein (%) | 22.4 |
| Crude fat (%) | 10.3 |
| Digestible lysine (%) | 1.06 |
| Digestible methionine + cystine (%) | 0.78 |

*The basal diet contained vitamin and trace-mineral levels common in Dutch practice.

No antibiotic growth promoter (except in the positive control) or coccidiostat were added to the diets. Body weight gain and feed conversion ratio were measured.

The effects of the antimicrobial growth promoter and different concentrations of arachidonic acid on body weight gain and feed conversion ratio in broilers between day 1 and 28 of age are shown below in Table 1.

TABLE 1

| | | | Feed |
|---|---|---|---|
| Exam- | | Body Weight | Conversion |
| ple | Treatment | Gain (g/bird) | Ratio (g/g) |
| 1 | Basal diet (negative control) | 1455 | 1.605 |
| 2 | Basal diet + antibiotic (positive | 1549 | 1.564 |
| | control) | | |
| 3 | Basal diet + arachidonic acid at a | 1536 | 1.561 |
| | concentration of 4 mg/kg | | |
| 4 | Basal diet + arachidonic acid at a | 1514 | 1.572 |
| | concentration of 2 mg/kg | | |
| 5 | Basal diet + arachidonic acid at a | 1494 | 1.589 |
| | concentration of 1 mg/kg | | |

Broilers fed with 4 mg/kg and 2 mg/kg of arachidonic acid showed significantly improved performance in comparison to the negative control (basal diet alone) as did those fed with the antimicrobial growth promoter (the positive control). Even the lowest ARA concentration (of 1 mg/kg) showed a tangible improvement.

### Comparative Examples 6 to 10

These Examples are presented to show that the higher PUFA concentrations demonstrate improved effects comparable to the much lower concentrations of PUFAs presented in other Examples.

Trials were carried out using male broilers (Cobb) to test the efficacy of varying concentrations of arachidonic acid in combination with the antimicrobial enzymes glucose oxidase and lysozyme. Directly after arrival from the hatchery the animals were randomly distributed over 30 cages with each cage housing 16 broilers. Six cages were allocated to each treatment and therefore each treatment was replicated six times (96 birds per treatment in total). The cages were set up in an artificially heated, illuminated and ventilated broiler house, using a three-tier cage system. The floor space of each cage was 0.98 m² and the cages had wire floors. The broiler house was illuminated 24 hours per day, with the light intensity gradually being decreased during the trial. The temperature of the broiler house was also decreased gradually during the experiment according to a practical schedule. The humidity during the trial was kept at approximately 60%. Animals were vaccinated according to the normal vaccination program against infectious Bronchitis and Newcastle disease virus. The experiment lasted until day 28 of age. The experiment comprised the following treatments (Examples 6 to 10):

(6) basal diet (negative control);

(7) basal diet+20 g/ton of the antimicrobial growth promoter avilamycine (positive control);

(8) basal diet+lysozyme (50,000 Shugar units/kg of feed)+glucose oxidase (1,000 Sarret units/kg of feed)+arachidonic acid to a final concentration of 0.5 g/kg feed;

(9) basal diet+lysozyme (50,000 Shugar units/kg of feed)+glucose oxidase (1000 Sarret units/kg of feed)+arachidonic acid to a final concentration of 1.0 g/kg feed; and

(10) basal diet+lysozyme (50,000 Shugar units/kg of feed)+glucose oxidase (1000 Sarret units/kg of feed)+arachidonic acid to a final concentration of 2.0 g/kg feed.

The arachidonic acid, antibiotic and enzymes were mixed into the basal diet as appropriate. The feed was pelleted at 2.5 mm diameter (the temperature of the pellets did not exceed approximately 70° C during this process). The feed was offered ad lib. to the animals as was water. Body weight gain (BWG) and feed conversion ratio (FCR) were determined.

The composition of the feed (basal diet) used was:

| Ingredients | Contents (%) |
|---|---|
| Wheat | 50.0 |
| Soybean meal | 22.6 |
| Full fat soybeans (toasted) | 5.0 |
| Manioc | 3.99 |
| Rapeseed meal | 5.0 |
| Fish meal | 1.0 |
| Feather meal | 1.0 |
| Soy oil | 0.3 |
| Blended animal fat | 7.0 |
| Mineral and vitamin premix* | 1.0 |
| Limestone | 1.24 |
| Monocalcium phosphate | 1.25 |
| Salt | 0.32 |
| L-lysine.HCl | 0.13 |
| DL-methionine | 0.16 |
| Natugrain ™ Blend | 0.01 |
| The calculated contents were: | |
| ME_{broilers} (MJ/kg) | 11.9 |
| Crude protein (%) | 21.9 |
| Crude fat (%) | 9.8 |
| Digestible lysine (%) | 1.05 |
| Digestible methionine + cystine (%) | 0.78 |

*The basal diet contained vitamin and trace-mineral levels as common in Dutch practice. No antibiotic growth promoter (apart from in the positive control) or coccidiostat were added to the diets.

The effects of the different concentrations of arachidonic acid in combination with glucose oxidase and lysozyme on body weight gain and feed conversion ratio are shown below in Table 2

TABLE 2

| | | | Feed |
|---|---|---|---|
| | | Body Weight | Conversion |
| Example | Treatment | Gain (g/bird) | Ratio (g/g) |
| 6 | Basal diet (negative control) | 1583 | 1.488 |
| 7 | Basal diet + antibiotic Positive | 1644 | 1.453 |
| | control) | | |
| 8 | Basal diet + glucose oxidase + | 1643 | 1.464 |
| | lysozyme + arachidonic acid | | |
| | (0.5 g/kg) | | |
| 9 | Basal diet + glucose oxidase + | 1613 | 1.468 |
| | lysozyme + arachidonic acid | | |
| | (1.0 g/kg) | | |
| 10 | Basal diet + glucose oxidase + | 1641 | 1.453 |
| | lysozyme + arachidonic acid | | |
| | (2.0 g/kg) | | |

Growth and feed conversion ratio improved (P<0.05) for broilers fed diets containing glucose oxidase, lysozyme and arachidonic acid. The results obtained with the highest concentration of arachidonic acid (2.0 g/kg, Example 10) were equivalent to those for the broilers fed the antimicrobial growth promoter (the positive control, Example 7). Note that the improvement was surprisingly of a similar magnitude to experiments in which the PUFA (ARA) concentration was reduced (by a factor of 5 at least).

### Comparative Examples 11 and 12 and Examples 13 and 14

Trials were carried out with broilers to test the efficacy of arachidonic acid, lysozyme and glucose oxidase either alone or in combination. The trial was performed using broilers housed in floor pens. Directly after arrival from the hatchery, the animals were randomly distributed over 32 pens with each pen containing 20 broilers. Eight pens were allocated to each treatment. Each treatment was therefore replicated eight times (160 animals per treatment). The pens were set up in an artificially heated, illuminated and ventilated broiler house. The climatic and hygienic conditions were kept similar to those commonly applied in practice. Animals were vaccinated according to the normal vaccination program. The experiment lasted until day 35 of age.

The experiment comprised the following treatments (Examples 11 to 14):

(11) basal diet (negative control);

(12) basal diet+20 g/ton of the antimicrobial growth promoter avilamycine (positive control);

(13) basal diet+arachidonic acid to a final concentration of 4 mg/kg; and

(14) basal diet+lysozyme (100,000 Shugar Units/kg of feed)+glucose oxidase (1,000 Sarret Units/kg of feed)+arachidonic acid to a final concentration of 4 mg/kg.

The arachidonic acid, antimicrobial growth promoter and enzymes were mixed into the basal diet as appropriate. The diets were then pelleted without the addition of steam. Feed and water were offered ad lib. to the animals. Body weight gain and feed conversion ratio were determined.

The composition of the feed (basal diet) used was:

| Ingredients | Contents (%) |
|---|---|
| Wheat | 61 |
| Soybean meal | 28 |
| Soy oil | 1 |
| Blended animal fat | 6 |
| Minerals, vitamins, amino acids | 4 |
| The calculated contents were: | |
| ME (MJ/kg) | 12.8 |
| Crude protein (%) | 21.0 |
| Crude fat (%) | 9.0 |

The diets were not supplemented with an antibiotic growth promoter (apart from in the positive control) or coccidiostat.

The effect of the arachidonic acid, lysozyme and glucose oxidase either alone or in combination on body weight gain and feed conversion ratio in broilers between day 1 and 35 of age are shown below in Table 3.

TABLE 3

| | | | Feed |
|---|---|---|---|
| | | Body Weight | Conversion |
| Example | Treatment | Gain (g/bird) | Ratio (g/g) |
| 11 | Basal diet (negative control) | 1819 | 1.649 |
| 12 | Basal diet + antibiotic (positive | 1903 | 1.489 |
| | control) | | |
| 13 | Basal diet + arachidonic acid | 1848 | 1.621 |
| 14 | Basal diet + lysozyme + | 1850 | 1.604 |
| | glucose oxidase + arachidonic | | |
| | acid | | |

Broilers fed the combination of arachidonic acid, lysozyme and glucose oxidase showed an improvement of body weight gain and feed conversion ratio. Broilers fed the diet containing the antimicrobial growth promoter showed a considerable improvement whilst those given arachidonic acid alone gave a satisfactory improvement (the latter being particularly surprising given the low concentration of the arachidonic acid).

### Comparative Examples 15 and 16 and Examples 17 to 22

Trials were performed using female and male broilers to determine the efficacy of varying concentrations of arachidonic acid in combination with different enzymes were performed. Directly after arrival from the hatchery, the animals were randomly distributed over 64 floor pens with each pen housing 15 broilers. Eight pens were allocated to each treatment each treatment was therefore replicated eight times (120 birds per treatment). The pens were set up in an artificially heated, illuminated and ventilated broiler house. The climatic conditions were as commonly applied. Animals were vaccinated according to the normal vaccination program. The experiment was performed until day 28 of age.

The experiments comprised the following treatments (Examples 15 to 22):

(15) basal diet (negative control);

(16) basal diet+10 mg/kg of the antimicrobial growth promoter avilamycin (positive control);

(17) basal diet+lysozyme (50,000 Shugar Units/kg)+glucose oxidase (1,000 Sarret Units/kg)+arachidonic acid to a total concentration of 4 mg/kg;

(18) basal diet+lysozyme (50,000 Shugar Units/kg)+glucose oxidase (200 Sarret Units/kg)+arachidonic acid to a total concentration of 4 mg/kg;

(19) basal diet+lysozyme (50,000 Shugar Units/kg)+glucose oxidase (100 Sarret Units/kg)+arachidonic acid to a total concentration of 4 mg/kg;

(20) basal diet+lysozyme (50,000 Shugar Units/kg)+phospholipase (500 units/kg)+arachidonic acid to a final concentration of 4 mg/kg;

(21) basal diet+lysozyme (50,000 Shugar Units/kg)+phospholipase (500 units/kg)+arachidonic acid to a final concentration of 2 mg/kg; and

(22) basal diet+lysozyme (50,000 Shugar Units/kg)+glucose oxidase (100 Sarret Units/kg)+arachidonic acid to a final concentration of 2 mg/kg.

The antimicrobial growth promoter, arachidonic acid and enzymes were mixed into the basal diet as appropriate. The feed was pelleted at 2.5 mm diameter and the temperature of the pellets did not exceed approximately 70° C. during this process. The feed was offered ad lib. to the animals, as was water. Body weight gain (BWG) and feed conversion ratio (FCR) were determined.

The composition of the feed (basal diets) used was:

| Ingredients | Contents (%) |
|---|---|
| Wheat | 42 |
| Rye | 10 |
| Soybean meal | 19 |
| Full fat soybeans (toasted) | 5 |
| Rapeseed meal | 7.5 |
| Soy isolate | 2.5 |
| Maize gluten meal | 2.5 |
| Soy oil | 2 |
| Blended animal fat | 6 |
| Minerals, vitamins and amino acids* | 3.5 |
| The calculated contents were: | |
| ME_{broilers} (MJ/kg) | 12.0 |
| Crude protein (%) | 22.4 |
| Crude fat (%) | 10.3 |
| Digestible lysine (%) | 1.06 |
| Digestible metbionine + cystine (%) | 0.78 |

*The diet contained vitamin and trace-mineral levels as common in Dutch practice. No antibiotic growth promoter (apart from in the positive control) or coccidiostat were added to the diets.

The effects of the antimicrobial growth promoter and different combinations of arachidonic acid and enzymes on body weight gain and feed conversion ratio in broilers between day 1 and 28 of age are shown below in Table 4.

TABLE 4

| | | | Feed |
|---|---|---|---|
| Exam- | | Body Weight | Conversion |
| ple | Treatment | Gain (g/bird) | Ratio (g/g) |
| 15 | Basal diet (negative control) | 1455 | 1.605 |
| 16 | Basal diet + antibiotic (positive | 1549 | 1.564 |
| | control) | | |
| 17 | Basal diet + lysozyme + glucose | 1531 | 1.549 |
| | oxidase (1,000 SrU/kg) + | | |
| | arachidonic acid (4 mg/kg) | | |
| 18 | Basal diet + lysozyme + glucose | 1515 | 1.568 |
| | oxidase (200 SrU/kg) + | | |
| | arachidonic acid (4 mg/kg) | | |
| 19 | Basal diet + lysozyme + glucose | 1517 | 1.571 |
| | oxidase(100 SrU/kg) + | | |
| | arachidonic acid (4 mg/kg) | | |
| 20 | Basal diet + lysozyme + | 1546 | 1.557 |
| | phospholipase + arachidonic acid | | |
| | (4 mg/kg) | | |
| 21 | Basal diet + lysozyme + | 1524 | 1.585 |
| | phospholipase + arachidonic acid | | |
| | (2 mg/kg) | | |
| 22 | Basal diet + lysozyme +glucose | 1561 | 1.561 |
| | oxidase (100 SrU/kg) + | | |
| | phospholipase + arachidonic acid | | |
| | (2 mg/kg) | | |

The results show that the combination of lysozyme, glucose oxidase and arachidonic acid was efficient in improving body weight gain and feed conversion ratio even with only low concentrations of arachidonic acid (and antimicrobial enzyme(s)). Phospholipase can replace (a part of) the arachidonic acid and glucose oxidase, but combining all products showed a slight further improvement to any of the other treatments.

1. An animal feed composition comprising from below 0.1 to 0.0001 g of a polyunsaturated fatty acid (PUFA) per kg of the animal feed composition.

2. An animal feed composition according to claim 1 comprising from 0.05 to 0.0001 g of a PUFA per kg of feed.

3. An animal feed composition according to claim 1 or 2 wherein the PUFA comprises an n-3 or n-6 C18, C20 or C22 PUFA and/or is of microbial, algal, single cell or plant origin.

4. A composition according to any preceding claim wherein the PUFA is in the form of a free fatty acid, salt, fatty acid ester, phospholipid or mono-, di- or triglyceride.

5. A composition according to any preceding claim wherein the PUFA comprises arachidonic acid (ARA) or is present in an oil.

6. A composition according to any preceding claim which further comprises an antimicrobial enzyme, optionally at least two antimicrobial enzymes.

7. A composition according to claim 6 wherein the antimicrobial enzyme is an antibacterial enzyme and optionally comprises glucose oxidase, sulphydryl oxidase, xanthine oxidase, peroxidase, lysozyme, beta-glucanase and/or phospholipase.

8. A composition according to claim 6 wherein at least one of the enzymes is
(a) able to disrupt the cell wall of bacteria;
(b) capable of generating a compound that is toxic to the bacteria;
(c) capable of removing (an) essential nutrient(s) for the bacteria; and/or
(d) is able to inactivate (an) enzyme(s) essential for growth.

9. A composition according to any one of claims 6 to 8 wherein the antimicrobial enzymes are two or more of lysozyme, an oxidase and a phospholipase and optionally all three.

10. A composition according to any one of claims 6 to 9 wherein the antimicrobial enzyme(s) is/are derived from an animal, an animal product, a plant, a plant product, an alga or an algal product or a microorganism and/or the antimicrobial enzyme(s) is/are of microbial origin or is/are a recombinant protein.

11. A composition according to any one of claims 6 to 10 wherein the antimicrobial enzyme is derived from, produced by or present in a microorganism such as a bacteria, yeast or (filamentous) fungus.

12. A composition according to claim 11 wherein the microorganism is of the genus Streptomyces, Bacillus, Escherichia, Saccharomyces, Kluyveromyces, Hansenula, Pichia, Yarrowia, Candida, Aspergillus, Trichoderma, Penicillium, Mucor, Fusarium or Humicola.

13. A composition according to claim 12 wherein the microorganism is Streptomyces lividans, Escherichia coli, Bacillus licheniformis, Kluyveromyces lactis Aspergillus niger, or Mortierella alpina.

14. A composition according to any one of claims 6 to 13 wherein the antimicrobial enzyme is contained in plant material, optionally obtained from a transgenic plant.

15. A composition according to claim 14 wherein the antibacterial enzymes glucose oxidase and/or lysozyme are contained in seeds of a transgenic plant.

16. A composition according to any one of claims 6 to 16 comprises from 10 to 10,000 Sarrett units of glucose oxidase per kg feed and/or 1,000 to 10,000,000 Shugar units of lysozyme per kg feed and/or 5 to 5,000 Egg Yolk units of phospholipase per kg of feed.

17. A composition according to any one of claims 6 to 16 which comprises from 0.05 to 50 milligrams of glucose oxidase protein per kg feed and/or 0.044 to 44 milligrams of lysozyme protein per kg feed and/or 0.005 to 5.0 milligrams of phospholipase protein per kg of feed.

18. An additive or premix composition for an animal feed comprising from 100 to 0.001 g of a PUFA per kg of composition.

19. A process for the preparation of an animal feed composition, comprising admixing a PUFA with one or more feed substance(s) or ingredient(s), or supplementing an animal feed with a PUFA, so that the PUFA is at a concentration of below 0.1 down to 0.001 g per kg of animal feed composition.

20. A composition according to claim 19 wherein the PUFA is from a natural (such as vegetable or marine) source or is produced by a single cell or microbial source.

21. A composition according to claim 19 or 20 wherein the PUFA is produced by a fungus, optionally of the genus Mucorales.

22. A composition according to any of claims 19 to 21 wherein the PUFA is produced by a fungus from Mortierella, such as M alpina.

23. A process for improving growth and/or feed conversion in a monogastric or non-ruminant animal, the process comprising feeding the animal a composition containing below 0.1 to 0.0001 g of a PUFA per kg of composition, a composition as defined in any of claims 1 to 17 or a composition preparable by a process according to claims 19 to 22.

24. A process according to claim 23 wherein the animal is a pig, poultry (chicken, turkey, laying hen), veal calf or aquatic animal.
